(19) United States
(12) Patent Application Publication
(10) Pub. No.: US 2015/0021898 A1
(43) Pub. Date: Jan. 22, 2015

(54) Vehicle fender extension for drilless assembly with receiving shoe

(71) Applicant: Andrew Serbinski, Frenchtown, NJ (US)

(72) Inventor: Andrew Serbinski, Frenchtown, NJ (US)

(21) Appl. No.: 13/987,349

(22) Filed: Jul. 17, 2013

(51) Int. Cl. B62D 25/16

(52) U.S. Cl. CPC B62D 25/163
USPC 280/851

(57) ABSTRACT

A vehicle fender extension component for drilless assembly to the leading or trailing end said vehicle fender includes a main body structure and a plurality of clamping elements. The main body structure has a top, bottom, front, back and first and second sides with downwardly extending flanges. The main body has a central axis that is arcuate with a radius, width and taper approximately equal to those of the said vehicle fender. At least two orifices are located on the first and second flange of the main body. The at least two clamping elements are positioned at the at least two orifices on the first and second flange and a central fender end receiving shoe is positioned to have the end of a fender pushed into it.

### BACKGROUND OF INVENTION

a. Field of Invention

The invention relates generally to motorcycle fender extensions for use on the leading or trailing end of a fender of a vehicle having one or more a definitive fenders, such as on the end of motorcycle, bicycle, or all-terrain vehicle fender. By “definitive fender” is meant a fender that has a defined shape that is distinguishable from the other body aspects of a vehicle. For example, autos generally have wheel wells without definitive or distinct fenders, whereas bicycles, tricycles, all-terrain vehicles, scooters and motorcycles do have definitive fenders. More specifically, the present invention relates to a vehicle fender extension that does not require any welds or physical modifications to a vehicle fender to attach the fender extension. Further, it requires the simplest if installation efforts due to the attachment mechanism, including a fender front end receiving shoe built into the present invention fender extension. The present invention is most favorably useful with motorcycles to achieve both appearance and performance improvements (extended fender look with increased water splash protection and tire protection).

b. Description of Related Art

The following patents are representative of the field pertaining to the present invention:

United States Patent Application Publication No. 2009/0079156 A1 to Ichihara describes a motorcycle rear fender assembly that includes a rear fender mounted on a vehicle frame structure above a vehicle rear wheel, which fender is divided, in a forward and rearward direction, into three components, including an anterior rear fender subassembly forming a front portion of the rear fender, an intermediate rear fender subassembly forming an intermediate portion of the rear fender, and a posterior rear fender subassembly forming a rear portion of the rear fender.

United States Patent Application Publication No. 2006/0284407 A1 to Iverson et al. describes the drilling of new holes into a vehicle fender fold is avoided by providing a mud flap with a rotating clamping member. A clamping arm of the rotating clamping member is rotated from a disengaged position to an engaged position behind the fender fold, and is then drawn forwardly on the threads of an attachment bolt to clamp the fender fold between the rotating clamping member and a stationary clamping member in-molded into the mud flap. A visual indicator may be provided to show whether the rotating clamping member is behind the vehicle fender fold to which the mud flap is to be attached.

U.S. Pat. No. 8,191,912 to Andrew Serbinski, the inventor herein, describes a motorcycle fender extension component for drilless assembly to the leading or trailing end of a motorcycle fender that includes a main body structure and a plurality of clamping elements. The main body structure has a top, bottom, front, back and first and second sides with downwardly extending flanges. The main body has a central axis that is arcuate with a radius, width and taper approximately equal to those of the motorcycle fender. At least three orifices are located on the first and second flange and main body. The at least three clamping elements are positioned at the at least three orifices on the first and second flange and on the main body away from the sides. The main body structure of the motorcycle fender extension component may be placed on a motorcycle fender and attached by fastening the clamps to sandwich the motorcycle fender between clamping elements and the main body structure. In other embodiments of the present invention motorcycle fender extension component the motorcycle fender is also included.

U.S. Pat. No. 4,422,659 to Nebu describes a rear fender structure for a motorcycle having a frame comprises a fender body fixedly attached to the motorcycle frame and a fender member removably joined to the fender body to provide easy access for removal of the rear wheel. The fender body can be hingedly connected to mounting means fixedly supported by the frame such as a tail bracket. The fender body can be removably secured to the tail light bracket.

U.S. Pat. No. 4,169,608 to Logan describes the specification discloses fender extensions which have inner flanges fitting inside and fastening to the inwardly turned flanges of motor vehicle fenders. The inner flanges press edges of outer, cover portions of the extensions tightly against the sides of the fenders. In an alternate embodiment, the inner flange is stepped to provide a shoulder abutting the side of the fender as an aid for proper positioning.

U.S. Pat. No. 3,934,900 to Wilson describes a combined fender and splash guard for a motorcycle comprises a single member injection molded of polypropylene and has a main fender portion and at least on splash guard integrally formed with the fender. The fender and splash guard can be doubled back on itself in a collision or spill without damage. Means are provided to attach the fender and integral splash guard to the motorcycle.

U.S. Design Pat. No. Des. 635,496 S to Andrew Serbinski, the inventor herein shows a motorcycle fender extension component utilizing three fastening clamp orifices.

U.S. Design Pat. No. Des. 293,312 to Stahel illustrates a motorcycle front fender extension. It has planar inside surfaces with no provision or direction for drilless attachment.

Notwithstanding the prior art, the present invention is neither taught nor rendered obvious thereby.

### SUMMARY OF INVENTION

The present invention is directed to a vehicle fender extension component for drilless assembly to either a leading end or trailing end of a vehicle with definitive fender(s). It includes a main body structure, the main body structure having a top, a bottom, a front, a back, a first side and a second side. Each of the first side and the second side has a downwardly extending flange. The main body structure has at least a portion with a central axis that is arcuate at a radius approximately equal to a radius of a vehicle fender to which it is attachable and has a width and taper approximately equal to the width and taper of the fender to which it is attachable. The main body structure has at least two orifices for receiving clamping elements, one of the at least two orifices is located on the first side flange, one of the at least two orifices is located on the second side flange. It also includes at least one fender-receiving shoe located on the main body structure away from the sides to receive and secure a fender end. A plurality of clamping elements is connected to the main body structure, including at least a first clamping element and a second clamping element. The first clamping element is positioned at the orifice on the first side flange and the second clamping element is positioned at the orifice on the second side flange.

In use, the main body structure of the fender extension component may be placed on a fender to which it is attachable, and the clamps may be fastened thereto so as to sandwich the fender between the clamping elements and the main body structure of the fender extension. The first clamping component is attached to a first side of the fender, the second clamping component is attached to a second side of the fender, and a fender end of the fender is inserted into and secured with the fender receiving shoe. In practice, it is the shoe that is first fitted onto the fender and then the clamping elements are secured.

In some preferred embodiments of the present invention fender extension component for drilless assembly to either a leading end or trailing end of a vehicle fender, the clamping elements each include a threaded receiving nut positioned at a main body structure orifice, a threaded fastener in and through the orifice and a clasp connected to one of the nut and the threaded fastener.

In some preferred embodiments of the present invention vehicle fender extension component for drilless assembly to either a leading end or trailing end of a vehicle fender, the clasp has distal claw and is connected to and integral with the nut.

In some preferred embodiments of the present invention vehicle fender extension component for drilless assembly to either a leading end or trailing end of a vehicle fender, the main body structure further includes an open area at said fender receiving shoe to expose an end of said fender during insertion thereof into said shoe.

In some preferred embodiments of the present invention vehicle fender extension component for drilless assembly to either a leading end or trailing end of a vehicle fender, the main body structure side flanges are recessed side flanges to enhance positioning of the vehicle fender extension component on the vehicle fender to which it is attachable to render it self-positioning.

In some preferred embodiments of the present invention vehicle fender extension component for drilless assembly to either a leading end or trailing end of a vehicle fender, the main body structure is symmetrical relative to the central axis.

In some preferred embodiments of the present invention vehicle fender extension component for drilless assembly to either a leading end or trailing end of a vehicle fender, the main body structure further includes an aerodynamically positioned pair of wings, one of each being located on the first side and the second side of the main body structure.

In some preferred embodiments of the present invention vehicle fender extension component for drilless assembly to either a leading end or trailing end of a vehicle fender, the pair of wings extends outwardly and upwardly from the main body structure.

In some preferred embodiments of the present invention vehicle fender extension component for drilless assembly to either a leading end or trailing end of a vehicle fender, the pair of wings has inside surfaces that are flat and form angles of about zero to about seventy five degrees when measured from an imaginary traversing line crossing through the sides of the main body structure at a right angle to the central axis.

In some preferred embodiments of the present invention vehicle fender extension component for drilless assembly to either a leading end or trailing end of a vehicle fender, the pair of wings has inside surfaces that are flat and form angles of about twenty to about sixty degrees when measured from an imaginary traversing line crossing through the sides of the main body structure at a right angle to the central axis.

In some other preferred embodiments the present invention is directed to, in combination, a motorcycle fender and a motorcycle fender extension component for drilless assembly to either a leading end or trailing end of the motorcycle fender. It includes a motorcycle fender having a top, a bottom and a front with a leading edge, a back with a trailing edge, a first side and a second side. It has at least a portion with a central axis that is arcuate at a predetermined radius and a predetermined width and a predetermined taper tapering away from the central axis. The motorcycle fender extension component attaches to one of the leading end and the trailing end of the motorcycle fender. The motorcycle fender extension component includes a main body structure. The main body structure has a top, a bottom, a front, a back, a first side and a second side. Each of the first side and the second side has a downwardly extending flange. The main body structure has at least a portion with a central axis that is arcuate at a radius approximately equal to the radius of the central axis of the motorcycle fender and has a width and taper approximately equal to the width and taper of the motorcycle fender. The main body structure has at least two orifices for receiving clamping elements, one of the at least two orifices is located on the first side flange, one of the at least two orifices is located on the second side flange. It also includes at least one fender-receiving shoe located on the main body structure away from the sides to receive and secure a fender end. A plurality of clamping elements is connected to the main body structure, including at least a first clamping element and a second clamping element. The first clamping element is positioned at the orifice on the first side flange and the second clamping element is positioned at the orifice on the second side flange. In use, the main body structure of the motorcycle fender extension component may be placed on a motorcycle fender to which it is attachable, and the clamps may be fastened thereto so as to sandwich the motorcycle fender between the clamping elements and the main body structure. The first clamping component is attached to a first side of the motorcycle fender, the second clamping component is attached to a second side of the motorcycle fender, and a fender end of the motorcycle fender is inserted into and secured with said fender receiving shoe.

Other features and details described above may be included in this combination of the motorcycle fender and a motorcycle fender extension component for drilless assembly to either a leading end or trailing end of the motorcycle fender.

Additional features, advantages, and embodiments of the invention may be set forth, included or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is an oblique side cut view of the leading edge of a front wheel and fender of a prior art vehicle, e.g., a motorcycle, with a vehicle fender extension component attached to the vehicle fender;

FIG. 2 shows an oblique front partial cut view of the fender and fender extension component of the present invention shown in FIG. 1;

FIG. 3 is a bottom view of the present invention fender extension component shown in FIGS. 1 and 2;

FIG. 4 is a front oblique view of the fender extension component shown in Figures though 3, without attachment to a fender and exposing more of the central fender receiving shoe;

FIG. 5 shows a front view of the present invention fender extension component shown in FIG. 4; FIG. 6 is a side view thereof; FIG. 7 is a back view thereof; and FIG. 8 is a top view thereof; and FIG. 9 is a bottom view thereof;

FIG. 10 is a perspective side view of a clamping element used in present invention vehicle fender extension component in an unconnected state, and;

FIG. 11 is a perspective side view of a clamping element shown in FIG. 10 in a fully connected state.

### DETAILED DESCRIPTION OF THE EMBODIMENTS

Referring now in detail to the drawings wherein like reference numerals designate corresponding parts throughout the several views, various embodiments of the present invention are shown.

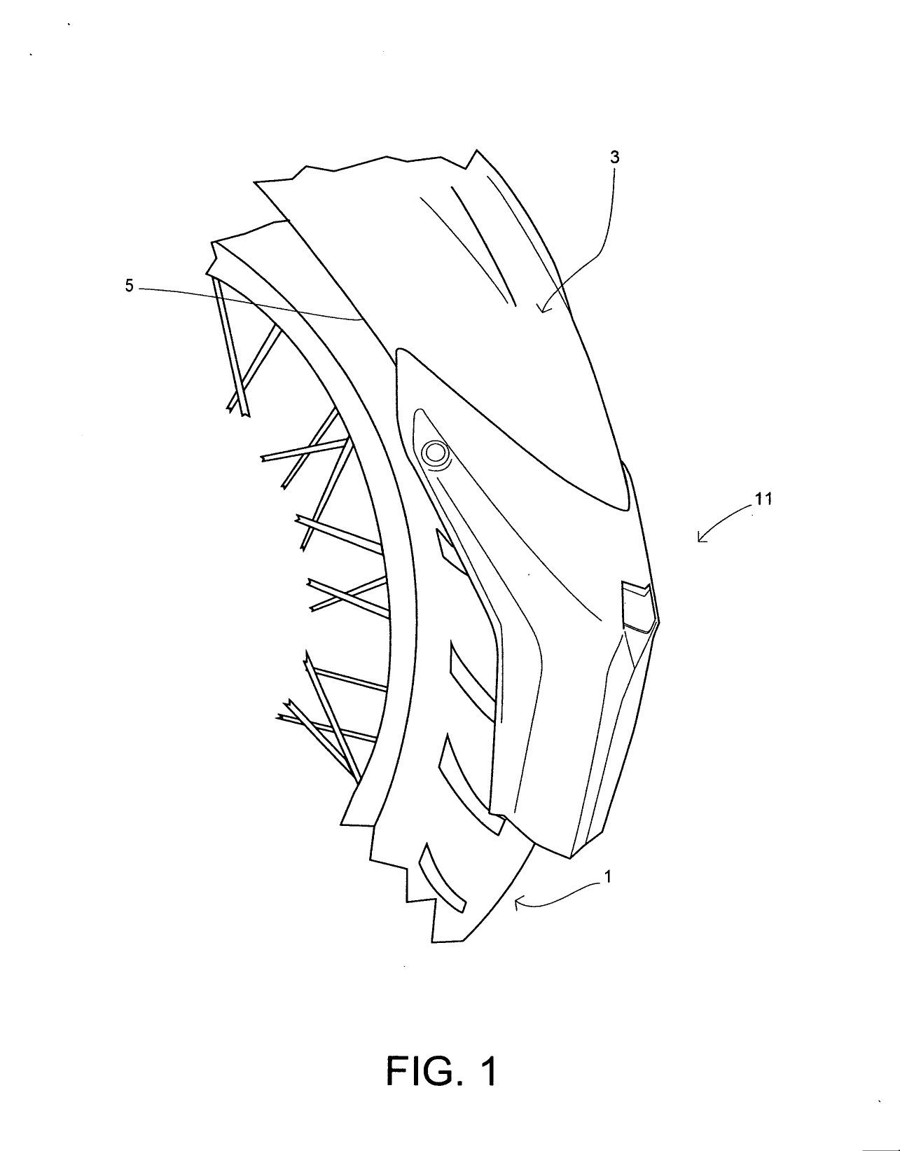

FIG. 1 is an oblique side cut view of the leading edge of a front wheel 1 and fender 3 of a prior art vehicle, e.g., a motorcycle, with a vehicle fender extension component 11 attached to the vehicle fender 3. A second side (not shown) is hidden from view opposite the first side 5 of the fender 3.

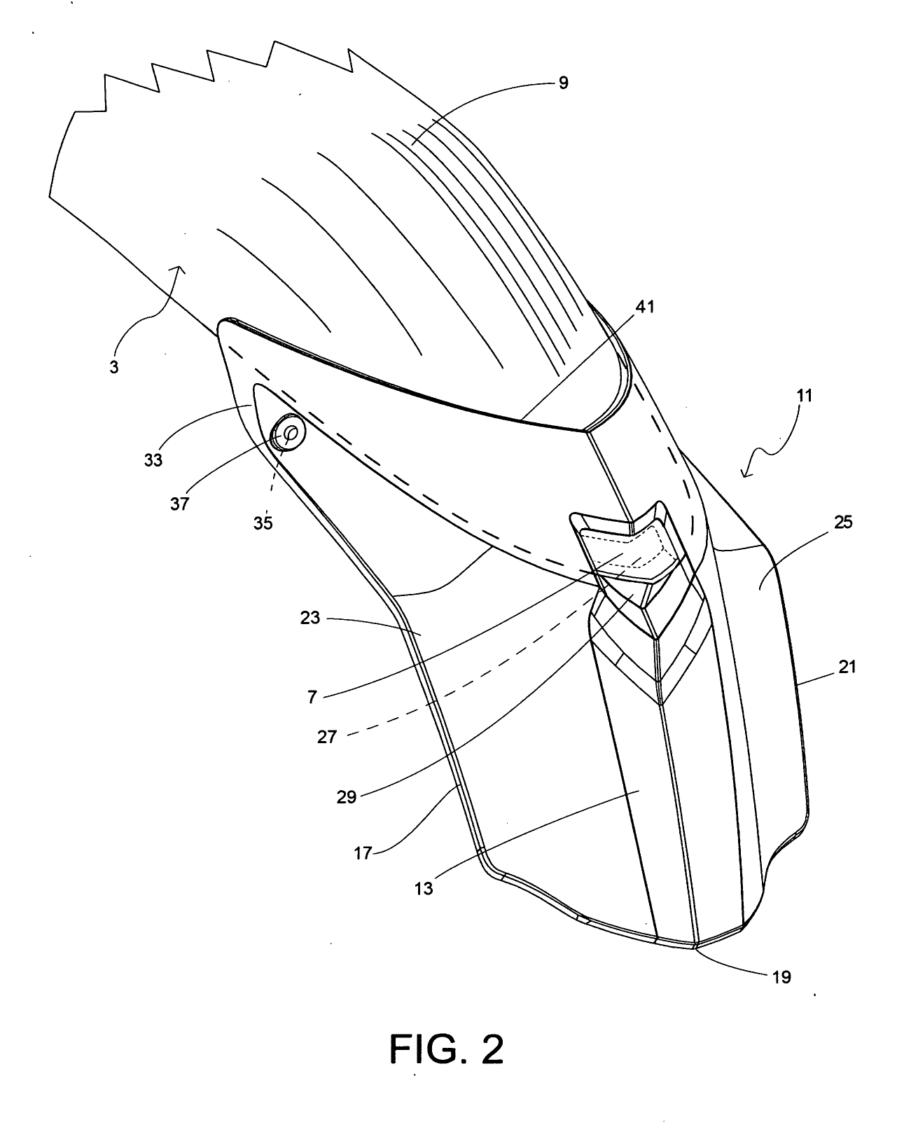

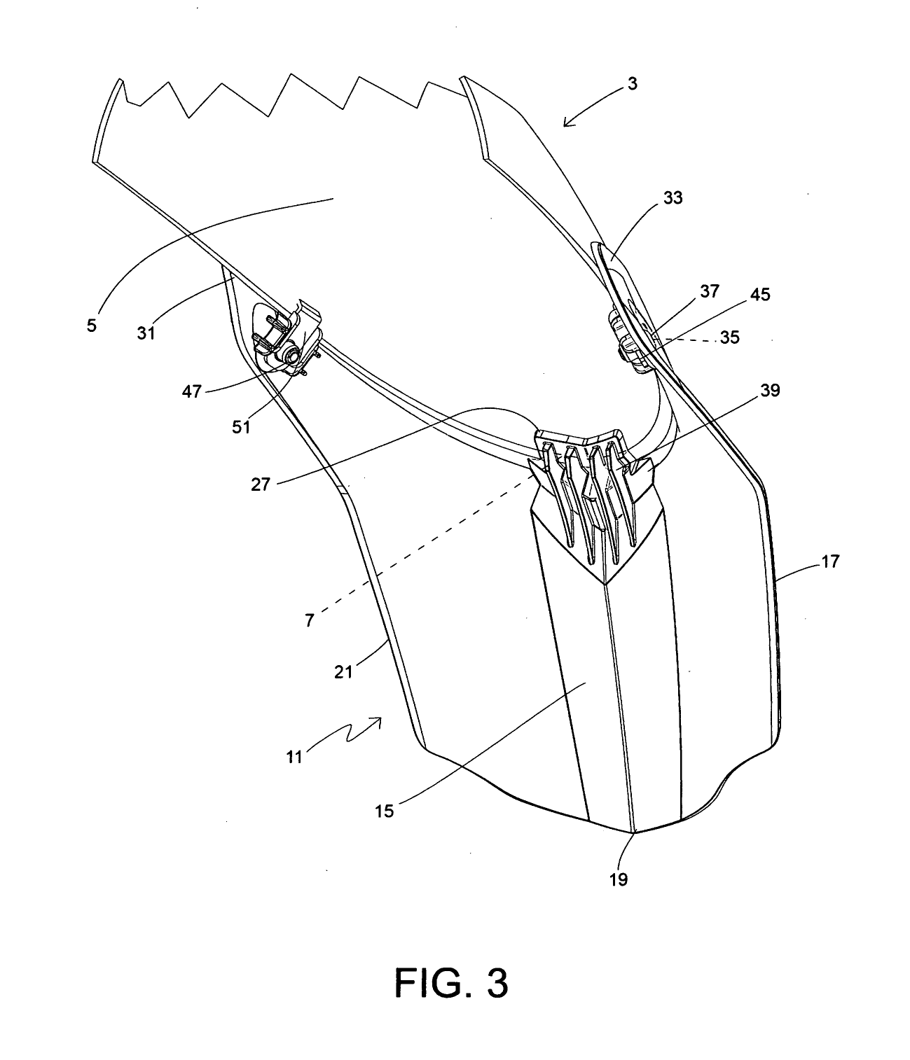

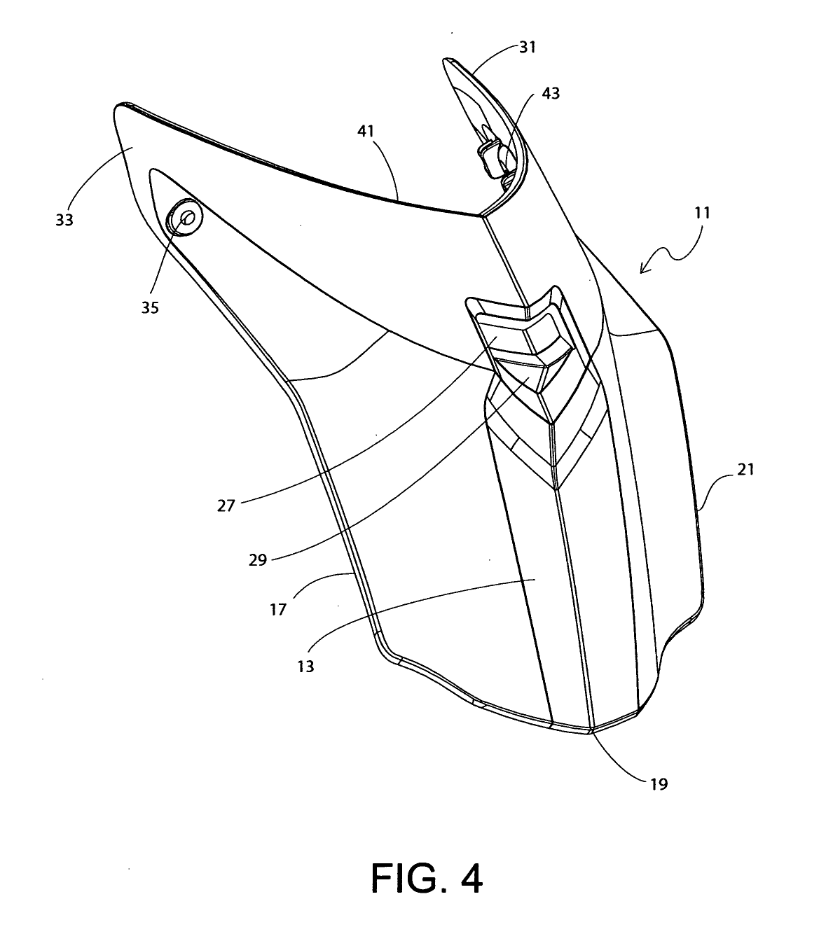

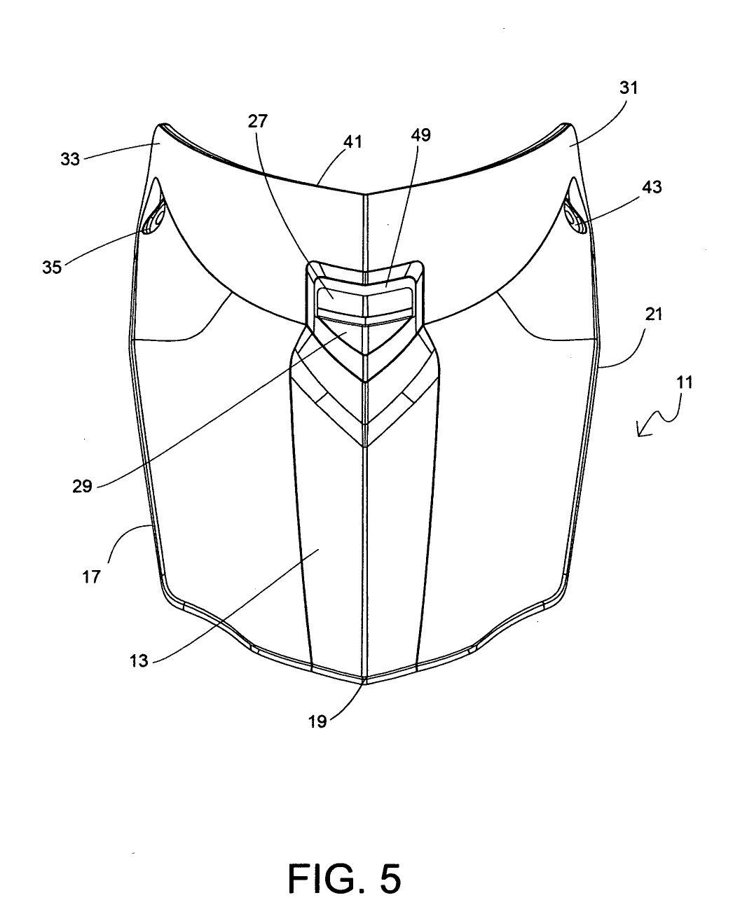

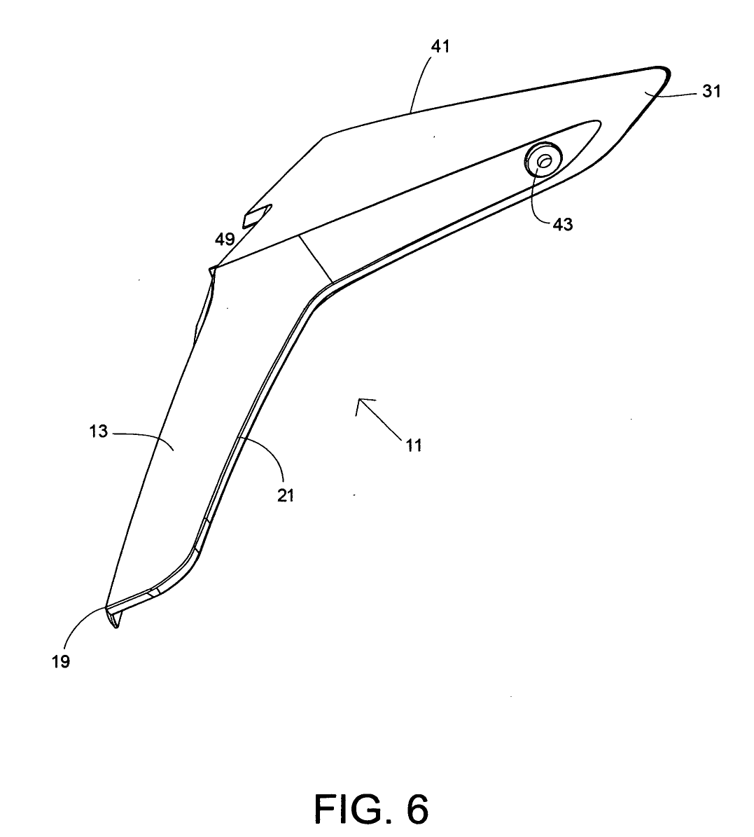

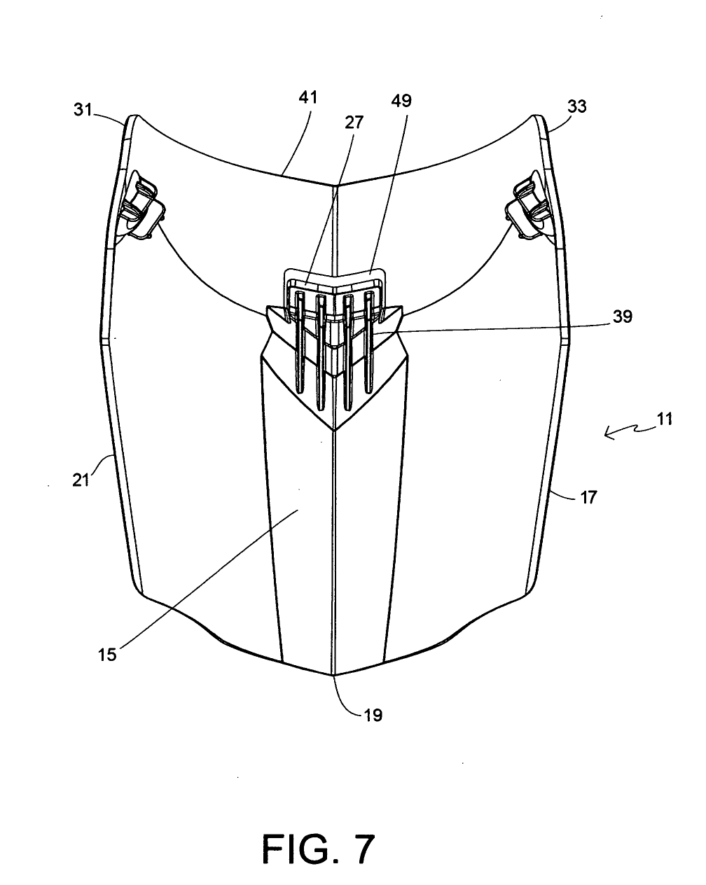

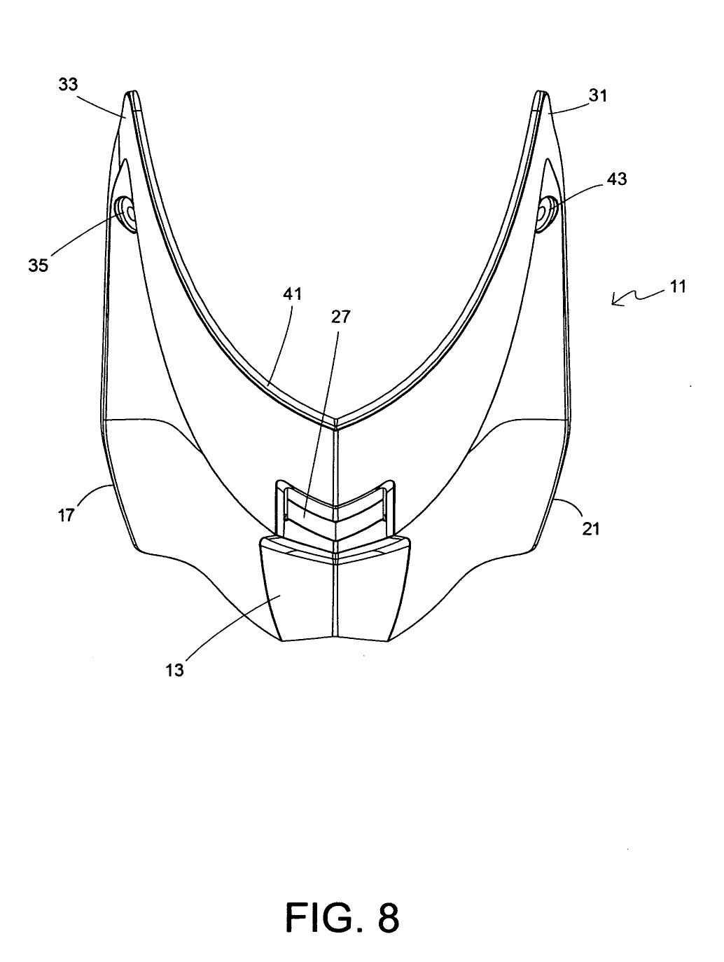

FIG. 2 shows an oblique front partial cut view of the fender 3 and fender extension component 11 of the present invention shown in FIG. 1. FIG. 3 is a bottom view of the present invention fender extension component 11 shown in FIGS. 1 and 2. FIG. 4 is a front oblique view of the fender extension component 11 shown in Figures though 3, without attachment to a fender and exposing more of the central fender receiving shoe 27. FIG. 5 shows a front view of the present invention fender extension component 11 shown in FIG. 4; FIG. 6 is a side view thereof; FIG. 7 is a back view thereof; and FIG. 8 is a top view thereof; and FIG. 9 is a bottom view thereof. These Figures are discussed collectively with the understanding that not all reference numerals are in all Figures. Further, while these Figures will now be described in terms of a motorcycle, it is understood that the fender could be from any other vehicle having definitive fender(s).

Figures parts list, indicating the reference number and corresponding part:

1—wheel

3—fender

5—side of fender

7—leading edge

9—fender top

11—fender extension component

13—front

15—back

17—fender extension left side

19—fender extension leading edge

21—fender extension right side

23—left wing section

25—right wing section

27—fender receiving shoe

29—receiving shoe cover

31—right side flange

33—left side flange

35—left side clamping element orifice

37—left side clamping element fastener

39—receiving shoe structural ribs

41—fender extension back edge

43—right side clamping element orifice

45—left side clamping element clasp

47—right side clamping element threaded fastener

49—space at receiving shoe

51—right side clamping element clasp

300—clamping element

301—clasp

303—threaded receiving nut

305—threaded fastener

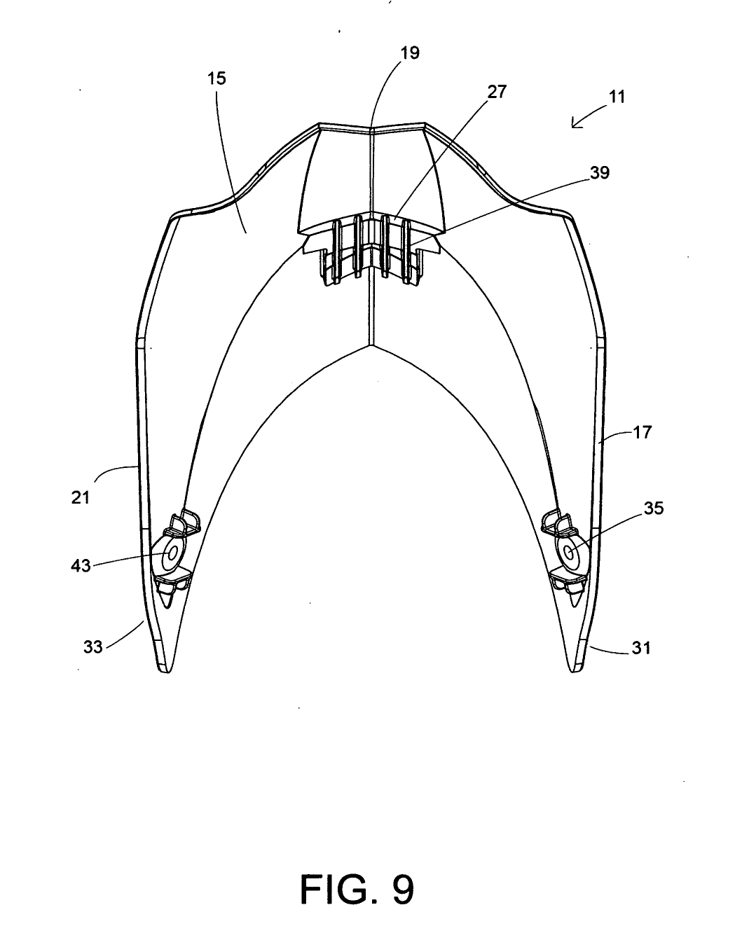

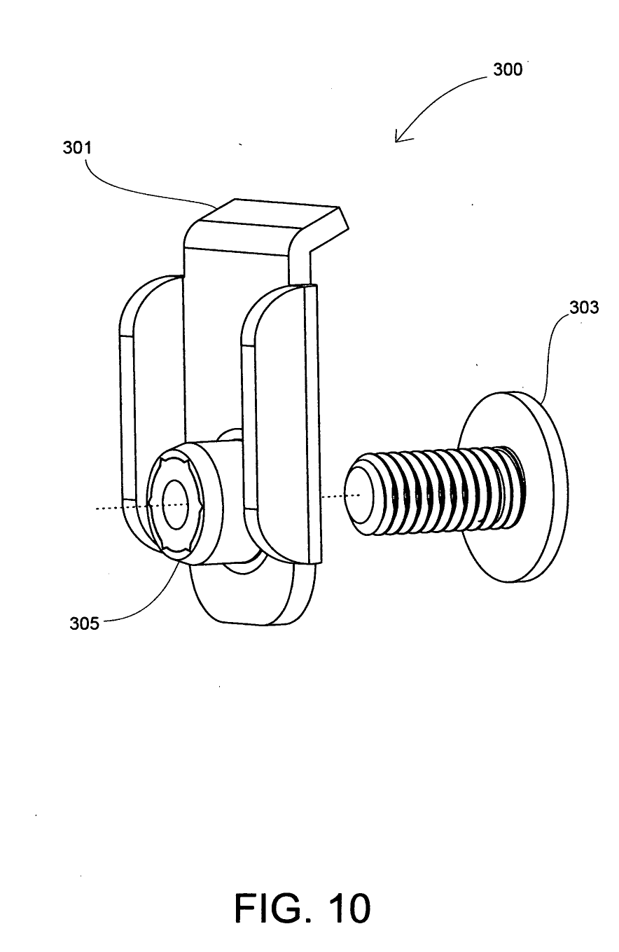

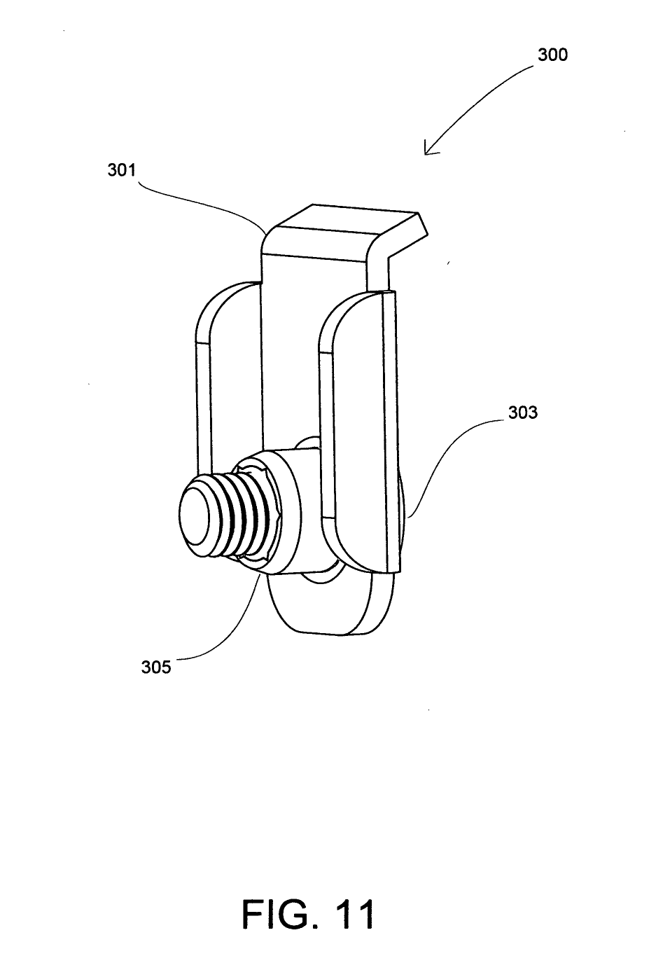

In the Figures, the motorcycle fender extension component 11 is attached to the motorcycle fender 3 in some of the FIGS. 1, 2 and 3) and removed from the subsequent Figures. Motorcycle fender 3 is formed as shown in the Figures, with the fender 3 partially visible and leading edge 7 partially seen by the fender extension component opening space 49 at shoe 27. The full leading edge is shown in FIG. 2 as the large dotted outline. The main body structure of the present invention motorcycle fender extension component 11 has a top 41, a bottom (leading edge 19), a front 13, a back 15, a left side 17 and a right side 21 and is symmetric relative to its central axis. The left side 17 has a flange 33 and right side 21 has a flange 31. Because vehicle fenders generally contour a wheel, they have arcute shapes. Hence, the central axis of the main body structure of the present invention extension is arcuate at a radius approximately equal to the radius of the motorcycle fender 3 to which it is attachable, and, in this embodiment, has a width and taper approximately equal to the width and taper of the motorcycle fender 3 to which it is attachable. (It could be wider or narrower than the fender, or not follow its general shape, without exceeding the scope of the present invention.) The main body structure has at two orifices, left side clamping element orifice 35 and right side clamping element orifice 43, for receiving clamping elements with fasteners 37 and 47 and clasps 45 and 51 (which may have separate nuts or nuts included in the clasps as more fully described in conjunction with FIGS. 10 and 11 below. As can be seen in the Figures, these orifices are located on flanges 31 and 33.

Significant to the present invention is the use of at least one fender receiving shoe 27. This reduces the number of orifices needed for attachment of the extension to a fender, reduces the hardware needed, reduces labor and utilizes the shoe for both alignment and attachment, making attachment very user friendly and easy to do. In this embodiment, shoe 27 is centrally located to receive the center of the fender leading or trailing edge, in this case fender leading edge 7, but it can now be seen that two or more symmetrically positioned shoes could alternatively be used. Shoe 27 has a top or cover 29, similar to the forward upper section of a foot shoe. The leading edge 7 force fits into or slides into the extension between shoe 27 and cover 29. Then the clamping elements are affixed to complete the simple assembly. In the back views, such as FIG. 7, the shoe 27 is seen as creating space 49 for receiving the fender leading edge 7 and securing it along with the clamping elements. Also shown are optional supporting structural ribs 39, which increase the strength of the shoe 27.

The present invention sample extension 11 also has optional wings 23 and 25, to enhance the extension 11 appearance, and is aerodynamically designed to enhance performance. In some other preferred embodiments of the present invention vehicle fender extension component, the wings described in the above paragraphs are not aerodynamically designed. The wings may continue the shape of the underlying fender in some preferred embodiments, or may take on another shape that is not necessarily aerodynamically shaped. In yet other embodiments, the wings are completely eliminated from the present invention vehicle fender extension component.

FIG. 10 is a perspective side view of the clamping element 300 used as components in the present invention fender extensions, in an unconnected state and FIG. 11 is a perspective side view of the clamping element 300 of FIG. 10 in a fully connected state. These two Figures are discussed collectively with the understanding that not all reference numerals are in all Figures. The clamping element 300 is attached to the main body structure (not shown) as described above and includes a threaded receiving nut 305, a threaded fastener 303 and a clasp 301. In some embodiments of the present invention, the clasp 301 may have a distal claw to aid in securing the present invention motorcycle fender extension component to a fender. In some embodiments, two of the three components are fixedly connected to one another, such as having the clasp 301 and threaded receiving nut 305 welded as or otherwise formed as one piece. In other preferred embodiments, all three components of the clamping element 300 are separate and moveable relative to one another. In yet other preferred embodiments of the clamping element 300, all three components are moveable relative to one another with two of the three components being seatable. For example, the clasp 301 may have a recessed area adapted to fit a matching threaded receiving nut 305 such that when the threaded receiving nut 305 is seated inside the clasp 301 the two components act as a single fixed piece. It is to be understood that the above examples are intended to illustrate possible configurations of the clamping element 300 and in no way limit the clamping element configuration.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A vehicle fender extension component for drilless assembly to either a leading end or trailing end of a vehicle fender on a vehicle having at least one definitive fender, which comprises:
a) a main body structure, said main body structure having a top, a bottom, a front, a back, a first side and a second side, each of said first side and said second side having a downwardly extending flange, said main body structure having at least a portion with a central axis that is arcuate at a radius approximately equal to a radius of a vehicle fender to which it is attachable and has a width and taper approximately equal to the width and taper of said vehicle fender to which it is attachable, said main body structure having at least two orifices for receiving clamping elements, one of said at least two orifices located on said first side flange, one of said at least two orifices located on said second side flange, and at least one fender receiving shoe located on said main body structure away from said sides to receive and secure a fender end;
b) a plurality of clamping elements connected to said main body structure including at least a first clamping element and a second clamping element, said first clamping element positioned at said orifice on said first side flange, and said second clamping element positioned at said orifice on said second side flange;
wherein said main body structure of said vehicle fender extension component may be placed on said vehicle fender to which it is attachable and said clamps may be fastened thereto so as to sandwich said vehicle fender to which it is attachable between said clamping elements and said main body structure and wherein said first clamping component is attached to a first side of said vehicle fender, said second clamping component is attached to a second side of said vehicle fender, and a fender end of said vehicle fender is inserted into and secured at said fender receiving shoe.

2. The vehicle fender extension component for drilless assembly to either a leading end or trailing end of said vehicle fender of claim 1 wherein said clamping elements each include a threaded receiving nut positioned at a main body structure orifice, a threaded fastener in and through said orifice and a clasp connected to one of said nut and said threaded fastener.

3. The vehicle fender extension component for drilless assembly to either a leading end or trailing end of a vehicle fender of claim 2 wherein said clasp has distal claw and is connected to and integral with said nut.

4. The said vehicle fender extension component for drilless assembly to either a leading end or trailing end of a vehicle fender of claim 1 wherein said main body structure further includes an open area at said fender receiving shoe to expose an end of said fender during insertion thereof into said shoe.

5. The said vehicle fender extension component for drilless assembly to either a leading end or trailing end of a vehicle fender of claim 1 wherein said main body structure side flanges are recessed side flanges to enhance positioning of said vehicle fender extension component on said vehicle fender to which it is attachable to render it self-positioning.

6. The said vehicle fender extension component for drilless assembly to either a leading end or trailing end of a vehicle fender of claim 1 wherein said main body structure is symmetrical relative to said central axis.

7. The said vehicle fender extension component for drilless assembly to either a leading end or trailing end of a vehicle fender of claim 1 wherein said main body structure further includes an aerodynamically positioned pair of wings, one of each being located on said first side and said second side of said main body structure.

8. The vehicle fender extension component for drilless assembly to either a leading end or trailing end of a vehicle fender of claim 7 wherein each of said pair of wings extends outwardly and upwardly from said main body structure.

9. The vehicle fender extension component for drilless assembly to either a leading end or trailing end of a vehicle fender of claim 8 wherein each of said pair of wings has inside surfaces that are flat and form angles of about zero to about seventy five degrees when measured from an imaginary traversing line crossing through said sides of said main body structure at a right angle to said central axis.

10. The vehicle fender extension component for drilless assembly to either a leading end or trailing end of a vehicle fender of claim 8 wherein each of said pair of wings has inside surfaces that are flat and form angles of about twenty to about sixty degrees when measured from an imaginary traversing line crossing through said sides of said main body structure at a right angle to said central axis.

11. In combination, a motorcycle fender and a motorcycle fender extension component for drilless assembly to either a leading end or trailing end of said motorcycle fender, which comprises:
A) a motorcycle fender having a top, a bottom, a front with a leading edge, a back with a trailing edge, a first side and a second side, and having at least a portion with a central axis that is arcuate at a predetermined radius, a predetermined width and a predetermined taper tapering away from said central axis;
B) a motorcycle fender extension component attached to one of said leading end and said trailing end of said motorcycle fender, said motorcycle fender extension component including:
a) a main body structure, said main body structure having a top, a bottom, a front, a back, a first side and a second side, each of said first side and said second side having a downwardly extending flange, said main body structure having at least a portion with a central axis that is arcuate at a radius approximately equal to said radius of said central axis of said motorcycle fender and has a width and taper approximately equal to the width and taper of said motorcycle fender, said main body structure having at least two orifices for receiving clamping elements, one of said at least two orifices located on said first side flange, one said at least two orifices located on said second side flange, and at least one fender receiving shoe located on said main body structure away from said sides to receive and secure a fender end;
b) a plurality of clamping elements connected to said main body structure including at least a first clamping element and a second clamping element, said first clamping element positioned at said orifice on said first side flange, and said second clamping element positioned at said orifice on said second side flange;
wherein said main body structure of said motorcycle fender extension component is placed on said motorcycle fender to which it is attachable and said clamps may be fastened thereto so as to sandwich said motorcycle fender to which it is attachable between said clamping elements and said main body structure and wherein said first clamping component is attached to a first side of said motorcycle fender, said second clamping component is attached to a second side of said motorcycle fender, and a fender end of said motorcycle fender is inserted into and secured at said fender receiving shoe.

12. The combination of motorcycle fender and motorcycle fender extension component for drilless assembly to either a leading end or trailing end of a motorcycle fender of claim 11 wherein said clamping elements each include a threaded receiving collar fixed in and through said main body structure, a threaded fastener in said collar and a clasp connected to said threaded fastener.

13. The combination of motorcycle fender and motorcycle fender extension component for drilless assembly to either a leading end or trailing end of a motorcycle fender of claim 12 wherein said clasp is a threaded clasp with a distal claw.

14. The combination of motorcycle fender and motorcycle fender extension component for drilless assembly to either a leading end or trailing end of a motorcycle fender of claim 11 wherein said main body structure further includes an open area at said fender receiving shoe to expose an end of said fender during insertion thereof into said shoe.

15. The combination of motorcycle fender and motorcycle fender extension component for drilless assembly to either a leading end or trailing end of a motorcycle fender of claim 11 wherein said main body structure of said motorcycle fender extension component is symmetrical relative to said central axis.

16. The combination of motorcycle fender and motorcycle fender extension component for drilless assembly to either a leading end or trailing end of a motorcycle fender of claim 11 wherein said motorcycle fender extension component main body structure further includes an aerodynamically positioned pair of wings, one of each being located on said first side and said second side of said main body structure.

17. The combination of motorcycle fender and motorcycle fender extension component for drilless assembly to either a leading end or trailing end of a motorcycle fender of claim 16 wherein said pair of wings are symmetrical relative to said central axis.

18. The combination of motorcycle fender and motorcycle fender extension component for drilless assembly to either a leading end or trailing end of a motorcycle fender of claim 16 wherein each of said pair of wings extends outwardly and upwardly from said main body structure.

19. The combination of motorcycle fender and motorcycle fender extension component for drilless assembly to either a leading end or trailing end of a motorcycle fender of claim 18 wherein each of said pair of wings has inside surfaces that are flat and form angles of about ten to about seventy five degrees when measured from an imaginary traversing line crossing through said sides of said main body structure at a right angle to said central axis.

20. The combination of motorcycle fender and motorcycle fender extension component for drilless assembly to either a leading end or trailing end of a motorcycle fender of claim 19 wherein each of said pair of wings has inside surfaces that are flat and form angles of about twenty to about sixty degrees when measured from an imaginary traversing line crossing through said sides of said main body structure at a right angle to said central axis.
